(19) United States
(12) Patent Application Publication
(10) Pub. No.: US 2026/0215645 A1
(43) Pub. Date: Jul. 30, 2026

(54) CLEANING BASE STATION AND CLEANING SYSTEM

(71) Applicant: Beijing Roborock Technology Co., Ltd., Beijing (CN)

(72) Inventors: Yongji LONG, Beijing (CN); Jianhao ZHAO, Beijing (CN); Yang WANG, Beijing (CN); Jianqiang SHAN, Beijing (CN); Yingku LI, Beijing (CN); Tianliang ZHU, Beijing (CN)

(21) Appl. No.: 19/144,489

(22) PCT Filed: Dec. 19, 2023
(86) PCT No.: PCT/CN2023/139846

§ 371 Date: Jun. 29, 2025

(30) Foreign Application Priority Data
Dec. 30, 2022 (CN) 202211730789.7

(51) Int. Cl. A47L 11/40

(52) U.S. Cl. CPC A47L 11/4016; A47L 11/4025; A47L 11/4027; A47L 11/4091; A47L 2201/024

(57) ABSTRACT

A cleaning base station and a cleaning system, are provided. The cleaning base station includes a wastewater discharging part, a liquid collecting part, and a heating assembly, wherein the liquid collecting part communicates with the wastewater discharging part, and the heating assembly is arranged on a side of the wastewater discharging part and configured to provide heat energy for the wastewater discharging part.

The present disclosure claims priority to Chinese Patent Application No. 202211730789.7, filed with the China National Intellectual Property Administration on Dec. 30, 2022 and entitled “CLEANING BASE STATION AND CLEANING SYSTEM” , the entire content of which is incorporated herein by reference.

### TECHNICAL FIELD

The present disclosure relates to the technical field of smart homes, and in particular to a cleaning base station and a cleaning system.

### BACKGROUND

With the development of science and technology, innovative breakthroughs continue to emerge across industries. Particularly in recent years, the intelligent robot technology has advanced by leaps and bounds. Among these developments, sweeping robots have gradually entered daily lives of ordinary families with artificial intelligence algorithms, washing and mopping integration, intelligent dust collection, intelligent water washing and cleaning and other technological innovations.

After a traditional cleaning system completes floor sweeping and floor mopping tasks and returns to a cleaning base station for intelligent dust collection and intelligent water washing, wastewater tends to accumulate in a narrow space on the bottom of the cleaning base station. This residual wastewater promotes bacteria growth and generates an unpleasant odor, which negatively affects user experience.

### SUMMARY

In a first aspect of the present disclosure, a cleaning base station is provided and includes: a wastewater discharging part; a liquid collecting part communicating with the wastewater discharging part; and a heating assembly arranged on one side of the wastewater discharging part and configured to provide heat energy for the wastewater discharging part.

In a second aspect of the present disclosure, a cleaning system is provided and includes: the cleaning base station as described above; and a cleaning device, the cleaning base station being used for cleaning the cleaning device.

### BRIEF DESCRIPTION OF THE DRAWINGS

Various other advantages and benefits will become apparent to those of ordinary skill in the art by reading the following detailed descriptions of preferred embodiments. The accompanying drawings are only for the purpose of showing the preferred embodiments, and are not considered as limiting the present disclosure. Moreover, the same components are denoted by the same reference signs throughout the drawings. In the figures:

FIG. 1 is a schematic structural diagram of a cleaning base station according to an embodiment of the present disclosure;

FIG. 2 is a schematic structural diagram of a heating assembly of the cleaning base station according to an embodiment of the present disclosure;

FIG. 3 is a schematic structural diagram of a partial structure of the cleaning base station in an exploded state according to an embodiment of the present disclosure;

FIG. 4 is a sectional schematic structural diagram of the cleaning base station according to an embodiment of the present disclosure from an angle;

FIG. 5 is a schematic structural diagram of a wastewater discharging tank of the cleaning base station according to an embodiment of the present disclosure;

FIG. 6 is a schematic structural diagram of a filtering part of the cleaning base station according to an embodiment of the present disclosure;

FIG. 7 is a schematic structural diagram of a filtering part of a cleaning base station according to another embodiment of the present disclosure;

FIG. 8 is a schematic structural diagram of a cleaning base station according to an embodiment of the present disclosure;

FIG. 9 is a schematic structural diagram of a wastewater discharging pipe of the cleaning base station according to an embodiment of the present disclosure;

FIG. 10 is a schematic structural diagram of the wastewater discharging pipe of the cleaning base station in an operation state according to an embodiment of the present disclosure; and FIG. 11 is a schematic structural diagram of the wastewater discharging pipe of the cleaning base station in another operation state according to an embodiment of the present disclosure.

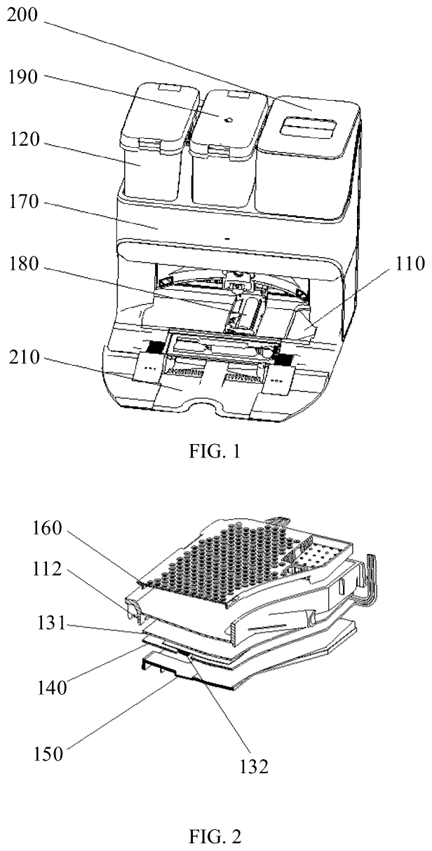

The corresponding relationships between the reference signs and component names in FIGS. 1 to 11 are as follows:

110 wastewater discharging part, 120 liquid collecting part, 130 heating assembly, 140 heat insulation part, 150 bottom cover, 160 filtering part, 170 housing, 180 cleaning assembly, 190 water supply part, 200 dust collecting part, and 210 guiding slope;

111 wastewater discharging pipe, 112 wastewater discharging tank, 131 heat conducting plate, 132 heat source, and 141 first heat dissipating hole; and

1111 liquid suction section, and 1112 non-return section.

### DETAILED DESCRIPTION

In order to better understand the above technical solutions, the technical solutions of the embodiments of the present disclosure will be described in detail through the accompanying drawings and specific embodiments. It should be understood that the embodiments of the present disclosure and the specific features in the embodiments are detailed descriptions of the technical solutions of the embodiments of the present disclosure, instead of limitations on the technical solutions of the present disclosure. In case of no conflict, the embodiments of the present disclosure and the technical features in the embodiments may be combined with each other.

As shown in FIGS. 1 to 7, according to the first aspect of the embodiments of the present disclosure, a cleaning base station is provided and includes a wastewater discharging part 110; a liquid collecting part 120, the wastewater discharging part 110 communicating with the liquid collecting part 120; and a heating assembly 130, which is arranged on one side of the wastewater discharging part 110 and configured to provide heat energy for the wastewater discharging part 110.

The cleaning base station according to the embodiment of the present disclosure includes the wastewater discharging part 110, the liquid collecting part 120 and the heating assembly 130. During operation, a cleaning device of a cleaning system can return to the cleaning base station for washing after completing a cleaning task, wastewater generated during washing can be discharged into the liquid collecting part 120 through the wastewater discharging part 110, and uniformly stored through the liquid collecting part 120. However, as some wastewater is still retained in the wastewater discharging part 110 and the wastewater discharging part 110 often adopts an open design, bacterial growth and unpleasant odor are likely to occur. Based on this, according to the cleaning base station provided by the embodiment of the present disclosure, the heating assembly 130 can be started to provide heat energy for the wastewater discharging part 110, so that the liquid retained in the wastewater discharging part 110 is removed by drying, which further greatly inhibits bacterial growth and greatly reduces the probability of unpleasant odor formation. This ensures cleaner and more hygienic operation of the cleaning base station, thereby improving the user experience.

In this technical solution, the heating assembly 130 is arranged on one side of the wastewater discharging part 110, for example, the heating assembly 130 is arranged on the lower side of the wastewater discharging part 110. Due to such an arrangement, the heating assembly 130 can be in contact with the wastewater discharging part 110, which allows the heat energy from the heating assembly 130 to directly act on the wastewater discharging part 110 and can improve the heat transfer efficiency and further improve the drying efficiency of the liquid.

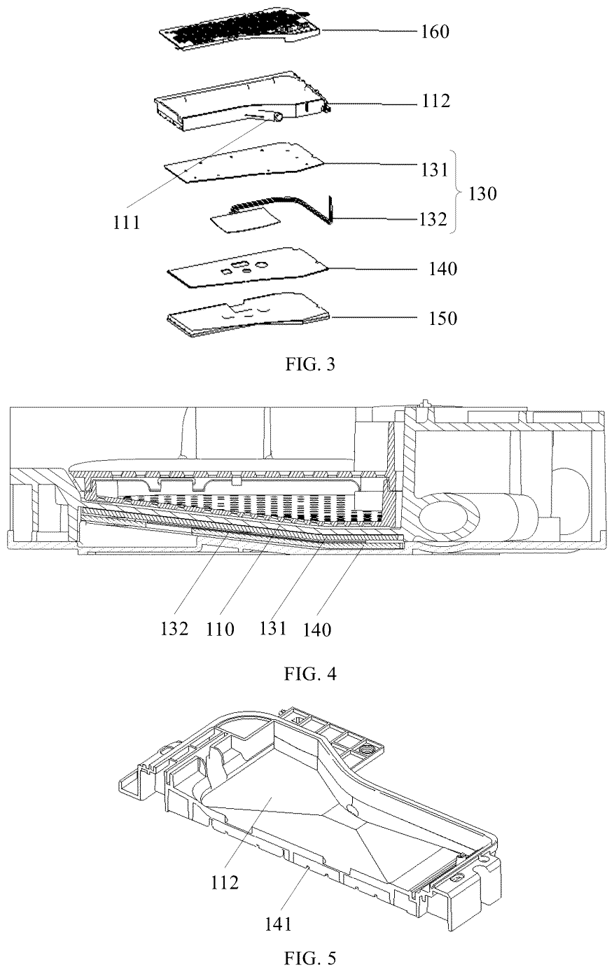

As shown in FIGS. 2 and 3, in a feasible embodiment, the wastewater discharging part 110 includes a wastewater discharging pipe 111 communicating with the liquid collecting part 120; and a wastewater discharging tank 112 communicating with the wastewater discharging pipe 111.

In this technical solution, the structural composition of the wastewater discharging part 110 is further provided. The wastewater discharging part 110 may include the wastewater discharging pipe 111 and the wastewater discharging tank 112. During washing of the cleaning device by the cleaning base station, the wastewater generated during washing may directly flow into the wastewater discharging tank 112, and then be transported into the liquid collecting part 120 through the wastewater discharging pipe 111. Such an arrangement facilitates wastewater discharge and recovery.

In some examples, the bottom surface of the wastewater discharging tank 112 is arranged obliquely.

In this technical solution, the bottom surface of the wastewater discharging tank 112 is obliquely arranged. Such an arrangement facilitates discharge of the wastewater into the wastewater discharging pipe 111, and better facilitates wastewater discharge and meanwhile can thus minimize the total amount of the residual wastewater. This facilitates removal of the wastewater retained in the wastewater discharging part 110 by the heating assembly 130 by drying, which further greatly inhibits bacterial growth and greatly reduces the probability of the unpleasant odor formation. This ensures the cleaner and more hygienic operation of the cleaning base station, thereby improving the user experience.

As shown in FIG. 5, in some examples, the wastewater discharging tank 112 may be funnel-shaped, and such an arrangement facilitates wastewater discharge.

As shown in FIGS. 2 and 3, in a feasible embodiment, the heating assembly 130 includes a heat conducting plate 131 arranged on one side of the wastewater discharging tank 112, for example, the heat conducting plate 131 being arranged on the lower side of the bottom surface of the wastewater discharging tank 112 and configured to provide heat energy for the wastewater discharging tank 112; and a heat source 132 arranged on a side of the heat conducting plate 131 away from the wastewater discharging tank 112 and configured to provide heat energy for the heat conducting plate 131.

In this technical solution, the structural composition of the heating assembly 130 is further provided. The heating assembly 130 may include the heat conducting plate 131 and the heat source 132. The heat source 132 may provide heat energy for the heat conducting plate 131, and the heat energy may be transferred to the wastewater discharging tank 112 through the heat conducting plate 131. Based on this, the wastewater in the wastewater discharging tank 112 can be removed by drying. By the arranging the heat conducting plate 131 and the heat source 132, the heat source 132 can be prevented from being in direct contact with the wastewater discharging tank 112, so that leakage of the liquid into the heat source 132 can be avoided, thereby improving the operation stability of the cleaning base station.

In this technical solution, the heat conducting plate 131 is made of a metal material. Such an arrangement enables the heat conducting plate 131 to transfer the heat energy to the wastewater discharging tank 112.

In this technical solution, the heat conducting plate 131 is arranged on one side of the wastewater discharging tank 112, and the heat source 132 is arranged on the side of the heat conducting plate 131 away from the wastewater discharging tank 112. For example, the heat source 132 is arranged in contact with the heat conducting plate 131 and is located on the lower side of a bottom plate of the heat conducting plate 131. Such an arrangement enables the heat conducting plate 131 to be in contact with the wastewater discharging tank 112, which allows the heat energy from the heat conducting plate 131 to directly act on the wastewater discharging tank 112 and can improve the heat transfer efficiency and further improve the drying efficiency of the retained liquid.

In this technical solution, the heat source 132 is arranged on the side of the heat conducting plate 131 away from the wastewater discharging tank 112, so that the heat energy from the heat source 132 can directly act on the heat conducting plate 131. In addition, the heat conducting plate 131 can play a role of separating the heat source 132 from the heat conducting plate, and can protect the heat source, and prevent the heat source from being contaminated by water vapor or dirt, thereby prolonging a service life of the heating assembly.

In a feasible embodiment, the heat conducting plate 131 is made of a metal material, and has a thickness of 0.8 mm to 3 mm.

In this technical solution, the thickness of the heat conducting plate 131 is 0.8 mm to 3 mm, which can ensure the heat conduction efficiency and meanwhile enables the heat energy to be uniformly supplied onto the wastewater discharging tank 112. If the thickness of the heat conducting plate 131 is less than 0.8 mm, then the heat energy output is possibly uneven, and the wastewater in a partial area of the wastewater discharging tank 112 cannot be effectively removed by drying. If the thickness of the heat conducting plate 131 is greater than 3 mm, then the heat conduction efficiency will be reduced and the energy consumption of the heat source 132 will be increased.

In some examples, in order to further improve the heat conduction efficiency, the heat conducting plate 131 may be made of an aluminum material.

In some examples, the heat source 132 may be a point-heating heat source 132 or a surface-heating heat source 132, for example, the heat source 132 may be a heating film, so that the heat energy can be uniformly supplied to the heat conducting plate 131.

In a feasible embodiment, the wastewater discharging tank 112 is made of a heat conduction material, the heating assembly 130 includes the heat source 132, and the heat source 132 is arranged on one side of the wastewater discharging tank 112, for example, the heat source 132 is arranged in contact with the wastewater discharging tank 112, located on the lower side of the bottom surface of the wastewater discharging tank and configured to provide heat for the wastewater discharging tank 112.

In this technical solution, the wastewater discharging tank 112 may be made of the heat conduction material. Due to such an arrangement, the heat energy of the heat source 132 can be directly transferred to the wastewater discharging tank 112. Such an arrangement facilitates simplifying the structure of the cleaning base station, especially the structure of the heating assembly 130, that is, the heating assembly 130 may only include the heat source 132 without the heat conducting plate 131.

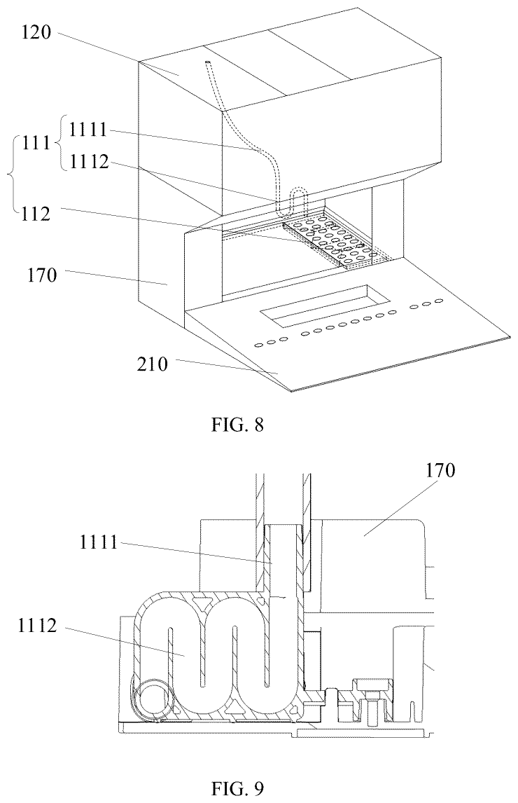

As shown in FIGS. 8 to 11, in a feasible embodiment, one end of the wastewater discharging pipe 111 communicates with the wastewater discharging tank 112, and the other end thereof communicates with the liquid collecting part 120; and the wastewater discharging pipe 111 includes a liquid suction section 1111 and a non-return section 1112, the liquid suction section 1111 communicates with the wastewater discharging tank 112 and the liquid collecting part 120, and the non-return sections1112 are located in a middle section of the liquid suction section 1111.

In this technical solution, the cleaning base station includes the liquid collecting part 120 and the wastewater discharging part 110, the wastewater discharging part 110 includes the wastewater discharging pipe 111 and the wastewater discharging tank 112, and the wastewater discharging pipe 111 includes the liquid suction section and the non-return section 1112. During use, the cleaning device of the cleaning system can return to the cleaning base station for washing after completing the cleaning task, and the wastewater generated during washing can be discharged into the liquid collecting part 120 through the wastewater discharging part 110, and uniformly stored through the liquid collecting part 120; and the wastewater discharging tank 112 can better hold the wastewater generated during washing and can thus prevent the wastewater from overflowing. The arrangement of the wastewater discharging pipe 111 facilitates discharge of the wastewater to the liquid collecting part 120. The non-return section 1112 is arranged on the wastewater discharging pipe 111. The arrangement of the non-return section 1112 can prevent the wastewater from flowing backwards, so that the liquid discharge of the wastewater discharging part 110 is more thorough. This reduces the liquid retained on the wastewater discharging part 110, which further greatly reduces the probability that the wastewater is retained in a narrow space on the bottom of the cleaning base station to cause bacterial growth and unpleasant odor formation. This ensures the cleaner and more hygienic operation of the cleaning base station, thereby improving the user experience.

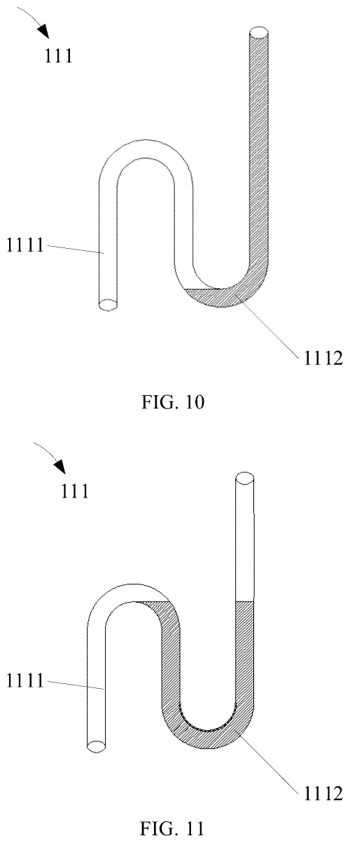

As shown in FIGS. 10 and 11, in which the shadow represents the wastewater, and a pipe body on the right side in FIGS. 3 and 11 is used for communicating with the liquid collecting part 120. In FIG. 10, an operation state of the wastewater discharging pipe is that a power source exerts a suction force on the wastewater and the wastewater is sucked, while in FIG. 11, the power source stops sucking the wastewater, the wastewater loses the suction force and will be accumulated in the non-return section 1112 under the action of gravity.

In some examples, in order to facilitate full discharge of the liquid in the wastewater discharging tank 112, the cleaning base station may further include a pump body, gas in the liquid collecting part 120 is pumped by the pump body to form a negative pressure, and then the wastewater in the wastewater discharging tank 112 is pumped into the liquid collecting part 120. By starting the pump body, the wastewater in the wastewater discharging tank 112 can be discharged under the negative pressure, and the wastewater discharge effect is better.

It can be understood that in order to improve the mechanical strength of the wastewater discharging pipe 111, the liquid suction section 1111 and the non-return section 1112 of the wastewater discharging pipe 111 may be of an integrated structure.

As shown in FIGS. 2 to 4, in a feasible embodiment, the non-return section 1112 includes a bent part, there may be a plurality of bent parts, and the bent part includes at least one of an S-shaped bent part, a V-shaped bent part and a U-shaped bent part.

In this technical solution, the style of the non-return section 1112 is further provided, and the non-return section 1112 may include one or more of the bent part, the S-shaped bent part and U-shaped bent part. Such an arrangement takes the following situation into account: in the traditional technology, when the power source is deactivated during wastewater suction, the liquid retained in the wastewater discharging pipe 111 will flow back to the liquid discharging tank under the action of gravity, which further leads to incomplete discharge of the liquid in the liquid discharging tank. As a result, the residual wastewater and dirt cannot be completely evacuated during wastewater and dirt suction, and there are more residues, which is prone to odor formation. For the wastewater discharging pipe 111 of the cleaning base station according to the embodiment of the present disclosure, through the arrangement of one or more of the bent part, the S-shaped bent part and the U-shaped bent part, when the power source is deactivated, the bent part, the S-shaped bent part or the U-shaped bent part can accumulate the liquid flowing back. Therefore, on the one hand, the accumulated liquid will not flow back into the wastewater discharging tank 112, which further enables the more thorough suction of the wastewater in the wastewater discharging tank 112 and reduces the probability of liquid retained in the wastewater discharging tank 112; and on the other hand, the liquid accumulated in the bent part, the S-shaped bent part or the U-shaped bent part can play a role of blocking the wastewater discharging pipe 111, which can reduce the probability of the unpleasant odor emission, thereby ensuring the more hygienic and cleaner operation of the cleaning base station.

In a feasible embodiment, there are two or more non-return sections 1112. Through the arrangement of the two or more non-return sections 1112, the non-return effect of the liquid can be further improved, and the liquid can be further inhibited from flowing back to the wastewater discharging tank 112.

As shown in FIGS. 2 and 3, in a feasible embodiment, the cleaning base station further includes a heat insulation part 140 arranged on a side of the heating assembly 130 away from the wastewater discharging part 110.

In this technical solution, the cleaning base station may further include the heat insulation part 140, and through the arrangement of the heat insulation part 140, the heat energy can be output to the wastewater discharging part 110, which greatly reduces waste of the heat energy and can reduce the energy consumption of the cleaning base station and further improve the user experience.

In a feasible embodiment, the heat insulation part 140 includes a first heat insulation layer arranged on the side of the heating assembly 130 away from the wastewater discharging part 110. An avoiding part is formed on the first heat insulation layer, and is used for avoiding devices on the heating assembly 130.

In this technical solution, the structural composition of the heat insulation part 140 is further provided. The heat insulation part 140 may include the first heat insulation layer, and the first heat insulation layer may be attached to the side of the heating assembly 130 away from the wastewater discharging part 110. Based on this, the heat energy will be more easily output to the wastewater discharging part 110, which can greatly reduce the waste of the heat energy, reduce the energy consumption of the cleaning base station and further improve the user experience; and further enables removal of the liquid retained in the wastewater discharging part 110 by drying and thus greatly inhibits bacterial growth and the probability of the unpleasant odor formation, thereby ensuring the more cleaner and hygienic operation of the cleaning base station and then improving the user experience.

In this technology, the avoiding part is formed on the first heat insulation layer. Due to such an arrangement, the devices of the heating assembly 130, such as fuses, reserved NTC and terminal dispensing protrusions on the heating assembly 130, can be avoided, so that the operation of the heating assembly 130 is more stable.

As shown in FIG. 5, in a feasible embodiment, the heat insulation part 140 includes a first air gap formed on the side of the heating assembly 130 away from the wastewater discharging part 110; and first heat dissipating holes 141 formed in a side part of the cleaning base station and communicating with the first air gap.

In this technical solution, the structural composition of the heat insulation part 140 is further provided and the heat insulation part 140 may include the first air gap. The thermal conductivity of air is low and the cost of heat insulation through the formation of the first air gap is low, which can greatly reduce the waste of the heat energy, reduce the energy consumption of the cleaning base station, and further improve the user experience; and further enables removal of the liquid retained in the wastewater discharging part 110 by drying and thus greatly inhibits bacterial growth and the probability of unpleasant odor formation, thereby ensuring the more cleaner and hygienic operation of the cleaning base station, and then improving the user experience.

In this technical solution, the heat insulation part 140 may also include the first heat dissipating holes 141, and the first heat dissipating holes 141 are formed in the side part of the cleaning base station and communicate with the air gap. Such an arrangement can achieve a heat dissipation effect and prevent the heat energy from being directly output to the floor of a user, thereby further improving the user experience.

In a feasible embodiment, the heat insulation part 140 includes a second heat insulation layer arranged on the side of the heating assembly 130 away from the wastewater discharging part 110; a second air gap formed on the side of the heating assembly 130 away from the wastewater discharging part 110; and second heat dissipating holes formed in a side part of the cleaning base station and communicating with the air gap. An avoiding part is formed on the second heat insulation layer, and used for avoiding devices on the heating assembly 130.

In this technical solution, the structural composition of the heat insulation part 140 is further provided. The heat insulation part 140 may include the second heat insulation layer and the second air gap, and the heat insulation layer may be attached to the side of the heating assembly 130 away from the wastewater discharging part 110. Based on this, the heat energy will be more easily output to the wastewater discharging part 110, which can greatly reduce the waste of the heat energy, reduce the energy consumption of the cleaning base station and further improve the user experience; and further enables removal of the liquid retained in in the wastewater discharging part 110 by drying and thus greatly inhibits bacterial growth and the probability of unpleasant odor formation, thereby ensuring the more cleaner and hygienic operation of the cleaning base station and then improving the user experience. The thermal conductivity of air is low and the cost of heat insulation through the formation of the second air gap is low, which can greatly reduce the waste of the heat energy, reduce the energy consumption of the cleaning base station and further improve the user experience; and enables removal of the liquid retained in the wastewater discharging part 110 by drying and thus greatly inhibits bacterial growth and the probability of the unpleasant odor formation, thereby ensuring the more cleaner and hygienic operation of the cleaning base station and further improving the user experience. The heat insulation effect can be improved through the arrangement of the second heat insulation layer and the second air gap. The heat insulation part 140 may also include the second heat dissipating holes, and the second heat dissipating holes are formed in the side part of the cleaning base station and communicate with the second air gap. Such an arrangement can achieve a heat dissipation effect and prevent the heat energy from being directly output to the floor of the user, thereby improving the user experience.

In this technology, the avoiding part is formed on the second heat insulation layer. Due to such an arrangement, the devices of the heating assembly 130, such as fuses, reserved NTC and terminal dispensing protrusions on the heating assembly 130, can be avoided, so that the operation of the heating assembly 130 is more stable.

As shown in FIGS. 2 and 3, in a feasible embodiment, the cleaning base station further includes a bottom cover 150 arranged on a side of the heat insulation part 140 away from the heating assembly 130.

In this technical solution, the cleaning base station may further include the bottom cover 150 arranged on the side of the heat insulation part 140 away from the heating assembly 130. Due to such an arrangement, the bottom cover 150 can, on the one hand, acts as a sealing component of the cleaning base station to enable the cleaning base station to be more aesthetic; and can, on the other hand, achieves a heat insulation effect, which can greatly reduce the probability that the heat energy is output to the floor of the user, thereby improving the user experience.

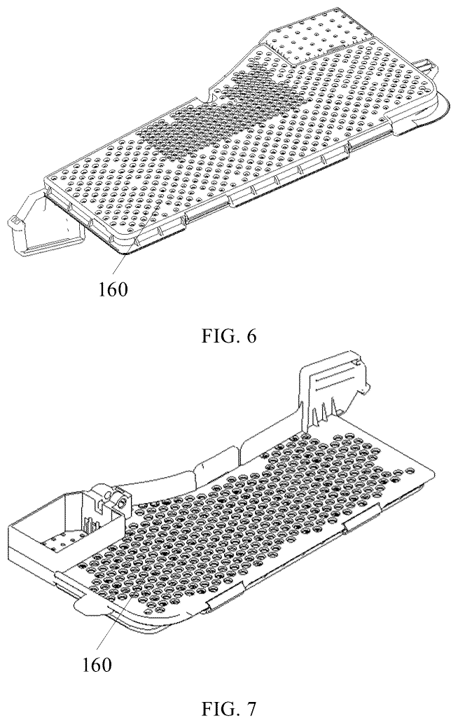

As shown in FIGS. 6 and 7, in a feasible embodiment, the cleaning base station further includes a filtering part 160, and the filtering part 160 covers the wastewater discharging part 110 and is provided with a plurality of through holes.

As shown in FIGS. 6 and 7, in this technical solution, the cleaning base station may further include the filtering part 160, the filtering part 160 covers the wastewater discharging part 110 and provided with the plurality of through holes. During operation, the wastewater generated during cleaning may first flow through the filtering part 160 for preliminary filtration, and then enter the wastewater discharging part 110. Due to such an arrangement, the granular garbage in the wastewater can be intercepted by the filtering part 160, which can avoid blockage of the wastewater discharging part 110.

In some examples, the density of the through holes is positively correlated with the depth of the wastewater discharging tank 112 of the wastewater discharging part 110.

As shown in FIGS. 6 and 7, in some examples, the through holes in the filtering part 160, can, on the one hand, achieve a filtering effect; and on the other hand, facilitate the discharge of water vapor generated after the wastewater in the wastewater discharging part 110 is heated. Therefore, the distribution of the through holes in the filtering part 160 can be uneven. For example, the lower the water level in the wastewater discharging part 110 is, the denser the distribution of the through holes is. Such an arrangement accounts for the higher liquid flow rates in deeper sections of the wastewater discharging tank 112. Therefore, by increasing the density of the through holes, the filtering effect can be improved.

As shown in FIG. 1, in a feasible embodiment, the cleaning base station further includes a housing 170, on which the wastewater discharging part 110, the liquid collecting part 120 and the heating assembly 130 are arranged; a cleaning assembly 180 movably connected to the housing 170; a water supply part 190 connected to the cleaning assembly 180; a dust collecting part 200 arranged on the housing 170 and communicating with the wastewater discharging part 110; and a guiding slope 210 arranged on the housing 170, one end of the guiding slope 210 being directed towards the cleaning assembly 180.

In this technical solution, the cleaning base station may also include the housing 170, the cleaning assembly 180, the water supply part 190, the dust collecting part 200 and the guiding slope 210. The housing 170 provides mounting positions for the wastewater discharging part 110, the liquid collecting part 120 and the heating assembly 130. During operation, after the cleaning device of the cleaning system completes the cleaning task, the cleaning device returns to the cleaning base station along the guiding slope 210 to be in position, and the dust collection and washing actions are started. At this time, the water supply part 190 supplies water to the cleaning assembly 180, the cleaning assembly 180 reciprocates to automatically clean a mop pad of the cleaning device, and the wastewater generated during cleaning is pumped to the liquid collecting part 120 through the wastewater discharging part 110 under negative pressure generated by an air pump through vacuum creation. As a small amount of wastewater is retained in the wastewater discharging part 110, the heating assembly 130 removes the residual wastewater by means of heating it and evaporating moisture; and the dust is collected by the dust collecting part 200. This greatly inhibits the bacterial growth and greatly reduces the probability of unpleasant odor formation, which ensures the cleaner and more hygienic operation of the cleaning base station, thereby improving the user experience.

As shown in FIGS. 1 to 7, according to the second aspect of the embodiments of the present disclosure, a cleaning system is provided and includes the cleaning base station according to any of the above technical solutions; and a cleaning device, the cleaning base station being used for cleaning the cleaning device.

For the cleaning system according to the embodiment of the present disclosure, since the cleaning system includes the cleaning base station in any of the above technical solutions, the cleaning system has all the beneficial effects of the cleaning base station in the above technical solution.

In some examples, the cleaning system may further include the cleaning device, and the cleaning device may be a cleaning robot. The cleaning base station of the cleaning system according to the embodiment of the present disclosure includes the wastewater discharging part 110, the liquid collecting part 120 and the heating assembly 130. During operation, the cleaning device of the cleaning system can return to the cleaning base station for washing after completing the cleaning task, the wastewater generated during washing can be discharged into the liquid collecting part 120 through the wastewater discharging part 110 and uniformly stored through the liquid collecting part 120. However, some wastewater is still retained in the wastewater discharging part 110 and the wastewater discharging part 110 often adopts an open design, which is prone to bacterial growth and unpleasant odor formation. Based on this, through the cleaning base station according to the embodiment of the present disclosure, the heating assembly 130 can be started to provide heat energy for the wastewater discharging part 110, so that the liquid retained in the wastewater discharging part 110 is removed by drying, which further greatly inhibits the bacterial growth and greatly reduces the probability of unpleasant odor formation. This ensures the cleaner and more hygienic operation of the cleaning base station, thereby improving the user experience.

In some examples, the cleaning system may also include the cleaning device, and the cleaning base station may also include the housing 170, the cleaning assembly 180, the water supply part 190, the dust collecting part 200 and the guiding slope 210. The housing 170 provides the mounting positions for the wastewater discharging part 110, the liquid collecting part 120 and the heating assembly 130. During operation, after the cleaning device of the cleaning system completes the cleaning task, the cleaning device returns to the cleaning base station along the guiding slope 210 to be in position, and the dust collection and cleaning actions are started. At this time, the water supply part 190 supplies water to the cleaning assembly 180, and the cleaning assembly 180 reciprocates to automatically clean a mop pad of the cleaning device, and the wastewater generated during cleaning is pumped to the liquid collecting part 120 through the wastewater discharging part 110 under negative pressure generated by an air pump through vacuum creation. As a small amount of wastewater is retained in the wastewater discharging part 110, the heating assembly 130 removes the residual wastewater by means of heating it and evaporating the moisture; and the dust is collected by the dust collecting part 200. This greatly inhibits the bacterial growth and greatly reduces the probability of the unpleasant odor formation, which ensures the cleaner and more hygienic operation of the cleaning base station, thereby improving the user experience.

In the present disclosure, the terms “first”, “second” and “third” are used for a descriptive purpose only and shall not be construed as indicating or implying relative importance; and the term “a plurality of” refers to two or more, unless otherwise specified. The terms “mount”, “connected”, “connection”, “fixed” and the like should be understood broadly. For example, the term “connection” may refer to a fixed connection, a detachable connection or an integrated connection; and the term “connected” may refer to directly connected or indirectly connected via an intermediate medium. For those of ordinary skill in the art, specific meanings of the foregoing terms in the present disclosure may be understood based on specific situations.

In the descriptions of the present disclosure, it should be understood that the orientation or positional relationships indicated by the technical terms such as “upper”, “lower”, “left”, “right”, “front” and “rear” are based on the orientation or positional relationships shown in the drawings, and are merely for describing the embodiments of the present disclosure and for simplifying the description, rather than indicating or implying that the apparatus or unit referred to must have a specific direction, or must be configured and operated in a specific orientation, Therefore, these terms should not be understood as limitations to the present disclosure.

In the description of the Description, the description of the terms such as “one embodiment”, “some embodiments”, and “specific embodiments” are intended to indicate that a specific feature, structure, material or characteristic described in combination with this embodiment or example is included in at least one embodiment or example of the present disclosure. In the Description, the schematic expressions of the above terms are not necessarily aimed at the same embodiment or example. In addition, the specific feature, structure, material or characteristic described may be combined in any one or more embodiments or examples in a suitable fashion.

Described above are only the preferred embodiments of the present disclosure, but not intended to limit the present disclosure. Various changes and modifications may be made to the present disclosure for those skilled in the art. Any modifications, equivalent substitutions, improvements, etc., made within the spirit and principles of the present disclosure should be included within the scope of protection of the present disclosure.

1. A cleaning base station, comprising:
a wastewater discharging part;
a liquid collecting part communicating with the wastewater discharging part; and
a heating assembly arranged on a side of the wastewater discharging part and configured to provide heat energy for the wastewater discharging part.

2. The cleaning base station according to claim 1, wherein the wastewater discharging part comprises:
a wastewater discharging pipe communicating with the liquid collecting part; and
a wastewater discharging tank communicating with the wastewater discharging pipe.

3. The cleaning base station according to claim 2, wherein the heating assembly comprises:
a heat conducting plate arranged on a side of the wastewater discharging tank and configured to provide heat energy for the wastewater discharging tank; and
a heat source arranged on a side of the heat conducting plate away from the wastewater discharging tank and configured to provide heat energy for the heat conducting plate.

4. The cleaning base station according to claim 3, wherein
the heat conducting plate is made of a metal material, and has a thickness of 0.8 mm to 3 mm.

5. The cleaning base station according to claim 2, wherein the wastewater discharging tank is made of a heat conduction material, the heating assembly comprises a heat source, and the heat source is arranged on a side of the wastewater discharging tank and configured to provide heat for the wastewater discharging tank.

6. The cleaning base station according to claim 2, wherein
the wastewater discharging pipe comprises a liquid suction section and a non-return section,
the liquid suction section communicates with the wastewater discharging tank and the liquid collecting part, and the non-return section is located in a middle section of the liquid suction section.

7. The cleaning base station according to claim 6, wherein
the non-return section comprises at least one bent part.

8. The cleaning base station according to claim 7, wherein the bent part comprises:
at least one of an S-shaped bent part, a V-shaped bent part, or a U-shaped bent part.

9. The cleaning base station according to claim 7, wherein two or more non-return sections are arranged.

10. The cleaning base station according to claim 1, further comprising:
a heat insulation part arranged on a side of the heating assembly away from the wastewater discharging part.

11. The cleaning base station according to claim 10, wherein
the heat insulation part comprises a first heat insulation layer arranged on the side of the heating assembly away from the wastewater discharging part,
wherein an avoiding part is formed on the first heat insulation layer, and the avoiding part is used for avoiding devices on the heating assembly.

12. The cleaning base station according to claim 10, wherein the heat insulation part comprises:
a first air gap formed on the side of the heating assembly away from the wastewater discharging part; and
first heat dissipating holes formed in a side part of the cleaning base station and communicating with the first air gap.

13. The cleaning base station according to claim 10, wherein the heat insulation part comprises:
a second heat insulation layer arranged on the side of the heating assembly away from the wastewater discharging part;
a second air gap formed on a side of the second heat insulation layer away from the wastewater discharging part; and
second heat dissipating holes formed in a side part of the cleaning base station and communicating with the second air gap,
wherein an avoiding part is formed on the second heat insulation layer, and the avoiding part is used for avoiding devices on the heating assembly.

14. The cleaning base station according to claim 10, further comprising:
a bottom cover arranged on a side of the heat insulation part away from the heating assembly.

15. The cleaning base station according to claim 1, further comprising:
a filtering part covering the wastewater discharging part and being provided with a plurality of through holes.

16. The cleaning base station according to claim 15, wherein
a density of the through holes is positively correlated with a depth of the wastewater discharging tank of the wastewater discharging part.

17. A cleaning system, comprising:
a cleaning base station, wherein cleaning base station comprises:
a wastewater discharging part;
a liquid collecting part communicating with the wastewater discharging part; and
a heating assembly arranged on a side of the wastewater discharging part and configured to provide heat energy for the wastewater discharging part; and
a cleaning device, the cleaning base station being used for cleaning the cleaning device.

18. The cleaning system according to claim 17, wherein the wastewater discharging part comprises:
a wastewater discharging pipe communicating with the liquid collecting part; and
a wastewater discharging tank communicating with the wastewater discharging pipe.

19. The cleaning system according to claim 18, wherein
the wastewater discharging pipe comprises a liquid suction section and a non-return section,
the liquid suction section communicates with the wastewater discharging tank and the liquid collecting part, and the non-return section is located in a middle section of the liquid suction section.

20. The cleaning system according to claim 19, wherein
the non-return section comprises at least one bent part.
